(19) United States
(12) Patent Application Publication
(10) Pub. No.: US 2020/0095130 A1
(43) Pub. Date: Mar. 26, 2020

(54) AMORPHOUS SILICA, DEVICE FOR PRODUCING AMORPHOUS SILICA, METHOD FOR PRODUCING AMORPHOUS SILICA, SILICON PRODUCED FROM AMORPHOUS SILICA, AND METHOD FOR PRODUCING SILICON

(71) Applicants: Hideo SAKAMOTO, Aichi (JP); Takahiro KINOSHITA, Hyogo (JP); JIKAN TECHNO, Inc., Hyogo (JP); LU-NAO. Co., Ltd., Osaka (JP)

(72) Inventors: Takahiro KINOSHITA, Hyogo (JP); Keishin OTA, Ibaraki (JP)

(73) Assignees: JIKAN TECHNO, Inc., Hyogo (JP); Hideo Sakamoto, Aichi (JP); LU-NAO. Co., Ltd., Osaka (JP); Takahiro Kinoshita, Hyogo (JP)

(21) Appl. No.: 16/425,110

(22) Filed: May 29, 2019

(30) Foreign Application Priority Data
Sep. 20, 2018 (JP) 2018-176672

(51) Int. Cl. C01B 33/023; C01B 33/107; C01B 33/037

(52) U.S. Cl. CPC C01B 33/023; C01P 2002/02; C01B 33/037; C01B 33/10757

(57) ABSTRACT

A method for producing amorphous silica includes: a pretreatment process of pulverizing vegetable material to obtain a silica source; a burning process of burning the silica source and extracting silica; and a purification process of removing carbon from burning material obtained in the burning process. The burning process includes a heating process of supplying an inert gas into a chamber and heating the silica source in the chamber in a plasma atmosphere.

### BACKGROUND OF THE INVENTION

### (1) Field of the Invention

The present invention relates to a producing device for efficiently extracting amorphous silica from a vegetable material, a method for producing the amorphous silica, silicon produced from the amorphous silica, and a method for producing the silicon.

### (2) Description of Related Art

Conventionally, silica which is fine silicon dioxide has a lower water absorption property than general powder has. Due to this property, silica is used for preventing solidification caused by moisture in cosmetics such as eye shadow and foundation, and is used in cream and milky lotion for stabilization, or the like. In addition, silicon dioxide is also used as negative electrode material for battery material using highly pure silicon.

Among these kinds of silica, crystalline silica is known to be a hazardous substance. However, amorphous silica is not designated as a hazardous substance and can be used for cosmetics, foods (including supplements), agricultural fertilizers, and feeds (for livestock and for pet animals).

For example, JP 2014-181144 A discloses chaff charcoal or rice straw charcoal rich in amorphous silica, obtained by using a carbonizing device to carbonize chaff or rice straw in an oxygen-free atmosphere while stirring the chaff or the rice straw. The temperature range for carbonizing the chaff or the rice straw in the carbonizing device is 500° C. to 700° C. Further, JP 2014-181144 A discloses an invention of a method of producing amorphous silica in which the chaff charcoal or the rice straw charcoal is stirred with ion-exchange water in the range of 30 to 100° C., and amorphous silica contained in the chaff charcoal or the rice straw coal is dissolved in the ion-exchange water to be extracted.

Patent document 1: JP2014-181144 A

### SUMMARY OF THE INVENTION

However, in the conventional producing method, since organic matter such as cellulose is burned to extract amorphous silica, if the temperature is too low, a firing process takes time and may take about 3 hours or longer. Therefore, the conventional method is not suitable for mass production and the extraction amount per hour is not much. Further improvement is required for mass production.

The present invention has been made to solve the above problems, and an object of the present invention to provide amorphous silica capable of extracting as much amorphous silica as possible and capable of increasing the extraction amount per hour, a device for producing the amorphous silica, a method for producing the amorphous silica, silicon produced from the amorphous silica, and a method for producing the silicon.

A method for producing amorphous silica includes:

a pretreatment process of pulverizing vegetable material to obtain a silica source;

a burning process of burning the silica source and extracting silica; and

a purification process of removing carbon from burning material obtained in the burning process,

the burning process including a heating process of supplying an inert gas into a chamber and heating the silica source in the chamber in a plasma atmosphere.

According to the above characteristics, the present invention is capable of producing amorphous silica inexpensively and efficiently in a short time, and enables production of highly pure amorphous silica and production of highly pure silicon by using the highly pure silica.

### BRIEF DESCRIPTION OF THE DRAWINGS

FIG. 1 is a diagram illustrating a process flow depicting production processes for silica ash generation according to an embodiment;

FIG. 2 is a schematic view illustrating a configuration of a plasma device according to a first embodiment;

FIG. 3 is a schematic view illustrating a configuration of a plasma device of another aspect of the first embodiment;

FIG. 4 is a schematic diagram illustrating a configuration of an impurity removing device according to the first embodiment;

FIG. 5 is a schematic diagram illustrating a configuration of a combustion furnace device according to a second embodiment;

FIG. 6 is a graph illustrating the relationship between heat temperature and the theoretical yield of silica ash in the production process according to the embodiment;

FIG. 7 is a block diagram illustrating a configuration of a silica ash producing device according to a third embodiment;

FIG. 8 is a schematic view illustrating the configuration of the silica ash producing device according to the third embodiment;

FIG. 9 is a cross-sectional view illustrating part of the silica ash producing device according to the third embodiment;

FIGS. 10A to 10C are schematic diagrams illustrating a part of the silica ash producing device according to the third embodiment; and

FIG. 11 is a diagram illustrating a process flow depicting silicon production processes according to the embodiment.

### DETAILED DESCRIPTION OF PREFERRED EMBODIMENTS

Amorphous silica, a device for producing the amorphous silica, a method for producing the amorphous silica, silicon produced from amorphous silica, and a method for producing the silicon according to the present invention will be described in detailed with reference to the drawings. Note that embodiments and drawings to be described below are examples of part of the embodiments of the present invention, are not intended to limit the present invention to these configurations, and can be appropriately modified within a range not deviating from the gist of the present invention.

### Biomass Material

A vegetable material 9 which is a biomass material for producing amorphous silica of a first embodiment or a second embodiment will be described. In the present invention, amorphous silica and silicon which are final products are produced by using the vegetable material 9 which is food residue or material to be discarded. Plants, lumber, or the like is used as the vegetable material 9. However, if a vegetable material 9 to be discarded such as residues generated when plants are harvested is used as raw material, it is possible to obtain raw material at low cost.

TABLE 1
Composition table of vegetable materials

| | C | N | P | P₂O₅ | K | K₂O | Ca | Mg | Na |
|---|---|---|---|---|---|---|---|---|---|
| Rice straw | 37.4 | 0.53 | 0.06 | 0.14 | 1.75 | 2.11 | 0.05 | 0.19 | 0.11 |
| Wheat straw | 40.3 | 0.67 | 0.08 | 0.18 | 1 | 1.21 | 0.21 | 0.11 | 0.06 |
| Barley straw | 41.8 | 0.58 | 0.08 | 0.18 | 1.4 | 1.69 | 0.29 | 0.1 | — |
| Rice bran | 40.2 | 1.18 | 0.9 | 2.06 | 1.1 | 1.33 | 0.01 | 0.7 | 0.07 |
| Chaff | 34.6 | 0.32 | 0.03 | 0.05 | 0.31 | 0.37 | 0.01 | 0.07 | 0.13 |
| Buckwheat straw | 40.3 | 1.08 | 0.21 | 0.48 | 3.13 | 3.77 | 1.35 | 0.14 | — |
| Soybean straw | 44.5 | 1.23 | 0.12 | 0.28 | 0.75 | 0.9 | 1.39 | 0.64 | 0.2 |
| Sweet potato vine | 42.7 | 3.74 | 0.22 | 0.5 | 3 | 3.62 | 1 | 0.17 | 0.12 |
| Turnip leaf | 39.8 | 3.33 | 0.27 | 0.62 | 4.35 | 5.24 | 1.7 | 0.8 | 0.49 |
| Carrot leaf | 41.4 | 2.63 | 0.25 | 0.57 | 4.2 | 5.06 | 0.56 | 0.19 | 0.51 |
| Corn culm | 43.8 | 0.92 | 0.09 | 0.21 | 1.32 | 1.59 | 0.24 | 0.12 | — |
| Sugar cane crown | 46.1 | 0.99 | 0.1 | 0.23 | 1.2 | 1.45 | 0.37 | 0.12 | 0.18 |
| Palm cake | 46.2 | 3.86 | 0.69 | 1.58 | 2.69 | 3.24 | 0.21 | 0.3 | 0.04 |
| Peanut shell | 51.1 | 0.75 | 0.02 | 0.06 | 0.47 | 0.57 | 0.17 | 0.05 | 0.05 |
| Mandarin orange | 44.5 | 0.76 | 0.05 | 0.11 | 0.58 | 0.7 | 0.4 | 0.06 | 0.07 |
| peel | | | | | | | | | |
| Red cedar sawdust | 51.1 | 0.07 | — | — | — | — | — | — | — |
| Bark of larch | 59.6 | 0.06 | — | — | — | — | — | — | — |
| Fallen leaf of ginkgo | 50.3 | 0.71 | 0.06 | 0.15 | 0.29 | 0.35 | 1.5 | 0.23 | 0.06 |

Table 1 is a composition table of the vegetable materials 9. In Table 1, ratios of the components constituting the raw material indicated in the leftmost column are indicated in percentage in the subsequent right columns. For example, rice straw contains 37.4% carbon (C), 0.53% nitrogen (N), 0.06% phosphorus (P), 0.14% phosphoric acid (P₂O₅), 1.75% potassium, 2.11% potassium oxide (K₂O), 0.05% calcium (Ca), 0.19% magnesium (Mg), and 0.11% sodium (Na).

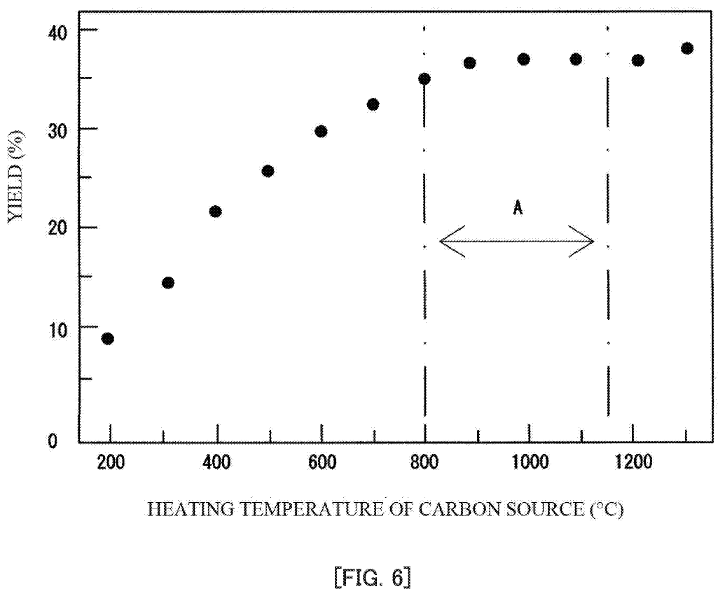

Here, as illustrated in FIG. 6, it is possible to extract silica in an amorphous state by burning the plant-derived silicon-containing porous vegetable material 9 at a low temperature (800° C. or higher and 1150° C. or lower). Many of the vegetable materials 9 have a structure in which cells are regularly arranged along the axis and silicic acid is deposited on the cell walls to thicken the cell walls.

There is a compressed narrow cell line between silicided cell lines and it is possible to obtain amorphous silica having a great specific surface area by removing a carbide after carbonization. As described above, the vegetable material 9 containing a large amount of, that is, 13% or more and 35% or less of silicic acid is suitable.

Table 1 illustrates examples of the vegetable material 9 which contains a relatively large amount of silicon. The examples include, in addition to rice straw, wheat straw, barley straw, rice bran,chaff, buckwheat straw, soybean straw, sweet potato vine, a turnip leaf, a carrot leaf, a corn calm, a sugar cane crown, a palm cake, a peanut shell, mandarin orange peel, red cedar sawdust, bark of larch, and a fallen leaf of ginkgo. In addition, a plant itself rather than the residue thereof may be used.

For example, bamboo contains fiber material made of cellulose, hemicellulose, lignin, and minerals such as iron, magnesium, calcium, manganese, copper, and nickel. In addition, when bamboo or a bamboo leaf is fired, a silanol group (Si—OH) is extracted and is converted into SiO₄, and SiO₄ is extracted in the process of firing.

TABLE 2
Composition table of vegetable material

| Water | Ash | | | Hemi- | | |
|---|---|---|---|---|---|---|
| content | content | Lipid | Lignin | cellulose | Cellulose | Others |
| 8~10% | 15~18% | 0.1~0.5% | 18~25% | 16~20% | 30~35% | 5~10% |

TABLE 3
Chemical composition table (wt %) of inorganic matter of
vegetable material

| SiO₂ | Al₂O₃ | CaO | Fe₂O₃ | K₂O | MgO | MnO | Na₂O |
|---|---|---|---|---|---|---|---|
| 92.14 | 0.04 | 0.48 | 0.03 | 3.2 | 0.16 | 0.18 | 0.09 |

Tables 2 and 3are composition tables of the vegetable material most suitable for the method of producing amorphous silica, or silicon, from among the vegetable materials 9 in Table 1 described above in the present invention. Table 2 illustrates ratios of the components constituting the raw material indicated in percentage. For example, water content is 8% to 10%, ash content is 15% to 18%, lipid is 0.1% to 0.5%, lignin is 18% to 25%, hemicellulose is 16% to 20%, cellulose is 30% to 35%, and others are 5% to 10%. As described above, main components of the organic matter which becomes a carbide are lignin, hemicellulose, and cellulose.

Table 3illustrates chemical composition of the inorganic matter of the vegetable material 9 illustrated in Table 2. In the vegetable material 9 illustrated in Table 2, the organic matter such as cellulose is 80 wt %, and the inorganic matter is 20 wt %. The chemical composition of the inorganic matter of Table 3 is as follows: SiO₂ is 92.14 wt % , Al₂O₃ is 0.04 wt % CaO is 0.48 wt %, Fe₂O₃ is 0.03 wt %, K₂O is 3.2 wt %, MgO is 0.16 wt %, MnO is 0.18 wt %, and Na₂O is 0.09 wt %. The vegetable material 9 illustrated in Table 2 contains a large amount of silicon oxide (SiO₂) as inorganic matter.

### First Embodiment

### Plasma Device 1

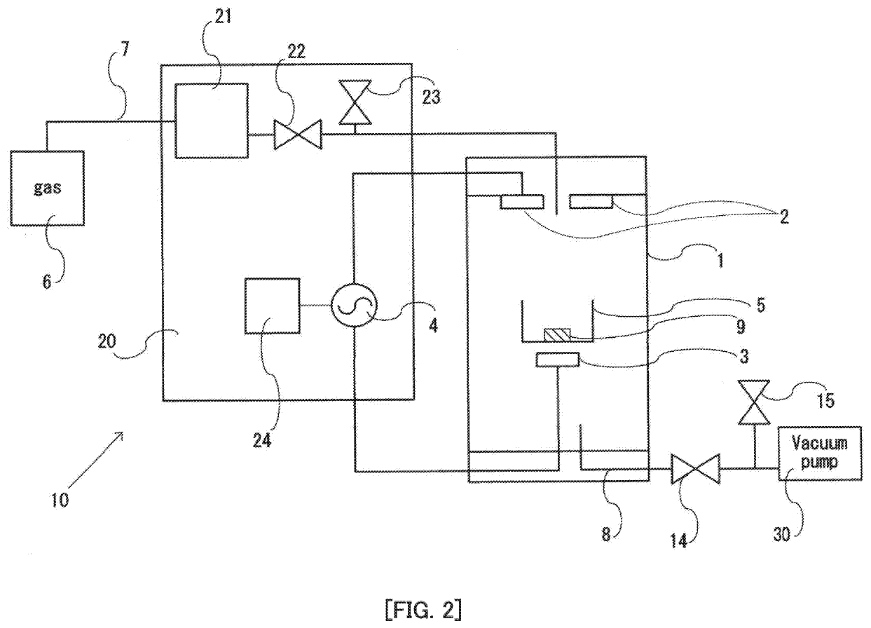

A plasma device 10 according to the first embodiment will be described with reference to FIG. 2. The present etttbodiment represents a burning process S2 of production processes to be described later. FIG. 2 is a schematic view illustrating a configuration of the plasma device 10 according to the first embodiment. The plasma device 10 mainly includes an inert gas 6, a control device 20, a chamber 1, and a vacuum pump 30.

Argon was mainly used as the inert gas 6 contained in a gas cylinder; however, examples of the inert gas 6 include helium, neon, and nitrogen. The inert gas 6 can be filled into the chamber 1 from an introduction pipe 7 via a gas amount control device 21. The gas amount control device 21 is capable of adjusting the flow rate of the inert gas 6.

The chamber 1 is connected to a control valve 22, and the inside of the chamber 1 can be depressurized to a vacuum state by the vacuum pump 30. The control valve 22 is connected to the chamber 1 to introduce the inert gas 6 into the chamber 1. A leak valve 23 for releasing the vacuum state in the chamber 1 to atmospheric pressure is provided between the control valve 22 and the chamber 1. A control valve 14 and a leak valve 15 for releasing the vacuum state in the chamber 1 to the atmospheric pressure are also provided between a lead-out pipe 8 for introducing the air in the chamber 1 and the vacuum pump 30.

In addition, a temperature control device 24 controls a high-frequency power supply 4 so as to manage temperature retention and temperature retention time, and the like inside the chamber 1. The plasma device 10 of the present first embodiment adopts a method of filling, as a working gas, argon gas which is the inert gas 6 described above under low pressure close to the vacuum state, and making a high current flow between a cathode 2 and an anode 3 which are electrodes, and obtaining thermal plasma produced by arc discharge. A crucible 5 made of carbon is disposed between the cathode 2 and the anode 3, and the above-described vegetable material 9 is put in the crucible 5. Silica ash 19 is extracted by heating the vegetable material 9 for about 10 to 30 minutes in the temperature range from 800° C. to 1150° C. by thermal plasma produced by arc discharge.

### Plasma Device 2

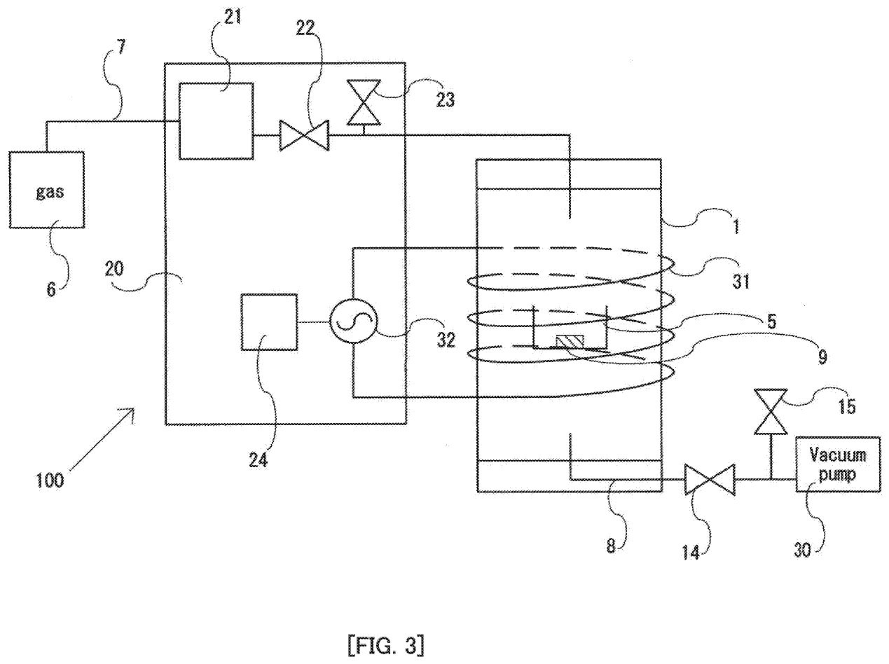

A plasma device 100 according to another modification of the first embodiment will be described with reference to FIG. 3. The present embodiment represents the burning process S2 of the production processes to be described later. In FIG. 3, the same reference numerals are given to portions representing the same configurations as those of the plasma device 10, and the portions having the same configuration will not be explained. The plasma device 100 mainly includes an inert gas 6, a control device 20, a chamber 1, and a vacuum pump 30. A main point of difference from the plasma device 10 is that in a method for producing thermal plasma, the inert gas 6 for plasma is made to flow, a high-frequency magnetic field of 4 MHz is applied from a high-frequency power supply 32 to a high-frequency coil 31 to produce thermal plasma. Silica ash 19 is extracted by heating the vegetable material 9 for about 10 to 30 minutes in a temperature range from 800° C. to 1150° C. by thermal plasma produced by arc discharge.

By using the plasma device 10, 100 as described above, even lignin which is difficult to be thermally decomposed can be decomposed.

Note that besides the plasma devices described above, there is a method of producing thermal plasma by a plasma device using barrier discharge, corona discharge, pulse discharge, and DC discharge.

### Impurity Removing Device

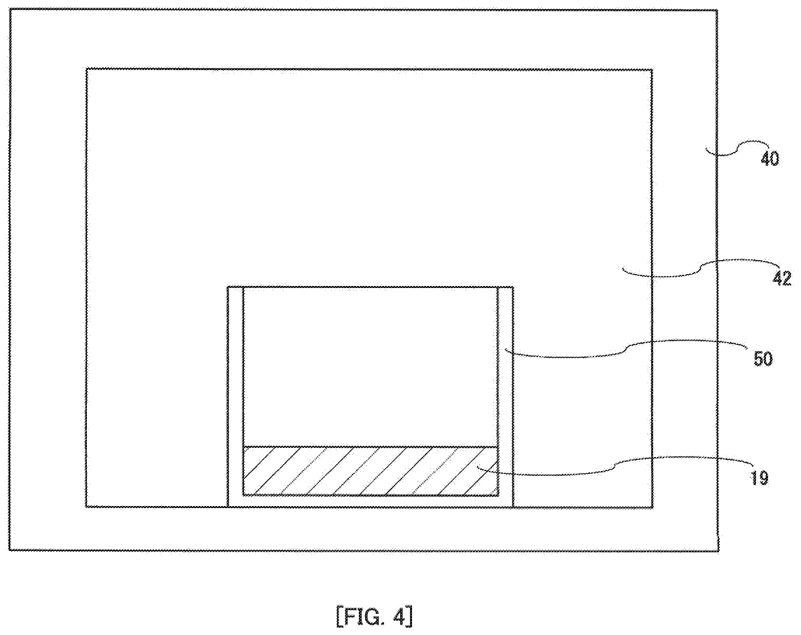

FIG. 4 illustrates an example of an impurity removing device 40 which removes impurities from the silica ash 19 obtained by burning the vegetable material 9 by the above-described plasma device 10, 100 to extract high purity silica. The present embodiment represents a purification process S3 of the production processes to be described later.

It is possible to heat a heating furnace 42 to a high temperature close to 2000° C. The silica ash 19 is put in the large crucible 50, the air is made to flow through the large crucible 50, and heating treatment is performed at a temperature of 600° C. or higher and 1000° C. or lower.

### Second Embodiment

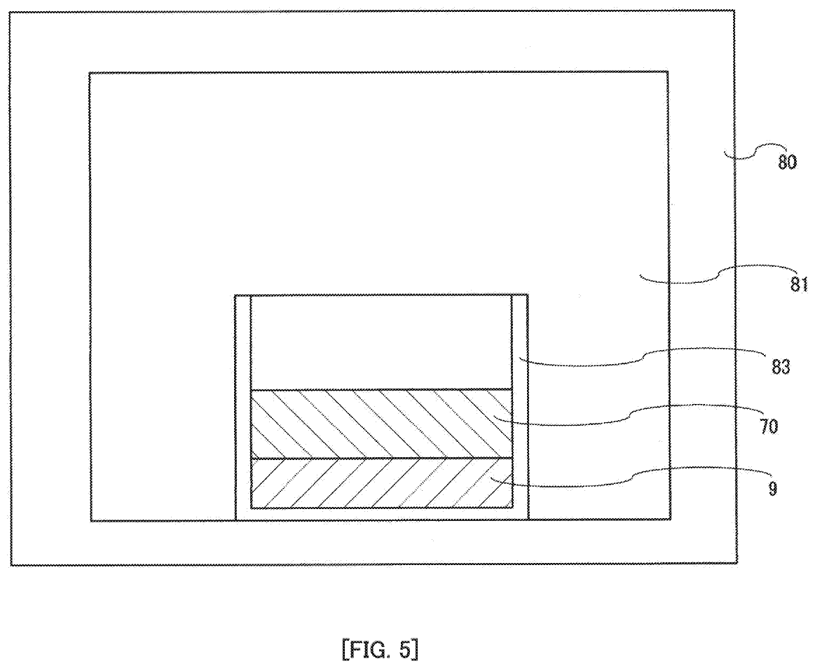

The same reference numerals are given to configurations the same to as those in the first embodiment and a description thereof will be omitted. The present embodiment represents the burning process S2 of the production processes to be described later. In FIG. 5, the vegetable material 9 produced from the vegetable material in the pretreatment process S1 as described in the first embodiment is placed in a pot 83. Here, it is preferable that the volume of the vegetable material 9 is about 1/10 to ⅔ of the capacity of the pot 83. In the pretreatment process S1, it is possible to only pulverize the vegetable material 9 with a mill or the like without using a granulating agent.

Here, oxidation inhibiting substance 70 may be any substance as long as the substance enables burning while suppressing oxygen concentration in order to prevent oxidation at the time of burning, and a gas or a liquid of a halide (carbon dioxide, nitrogen, Halon 2402, Halon 1121, Halon 1301) may be mixed and burned.

Thereafter, the atmosphere in a furnace 81 of a combustion furnace 80 is set to 800° C. or higher, and the vegetable material 9 is burned for 3 to 5 hours under the conditions of 20 atm and 400° C. or higher and 900° C. or lower.

### Third Embodiment

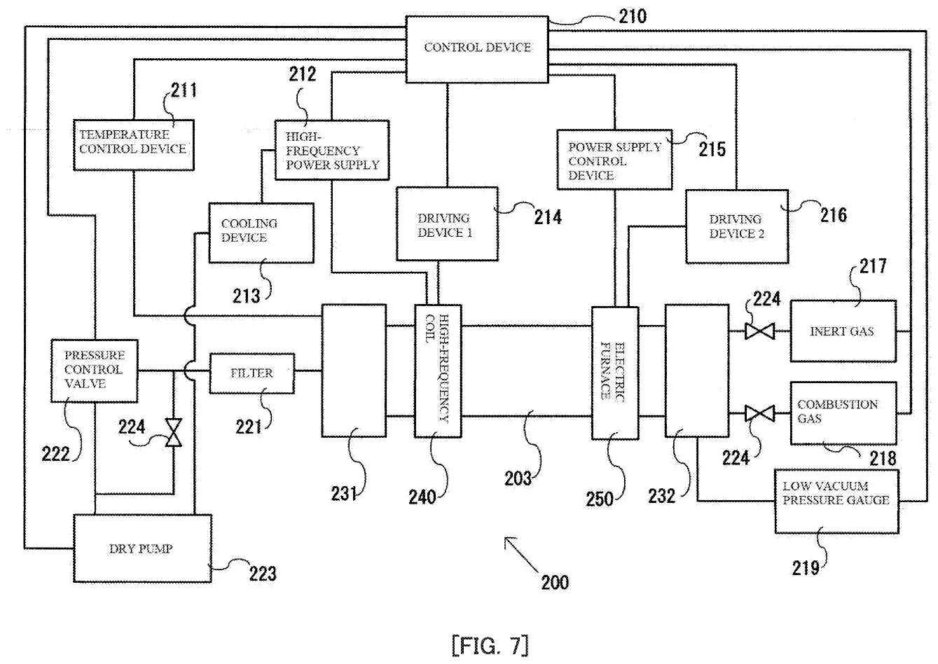

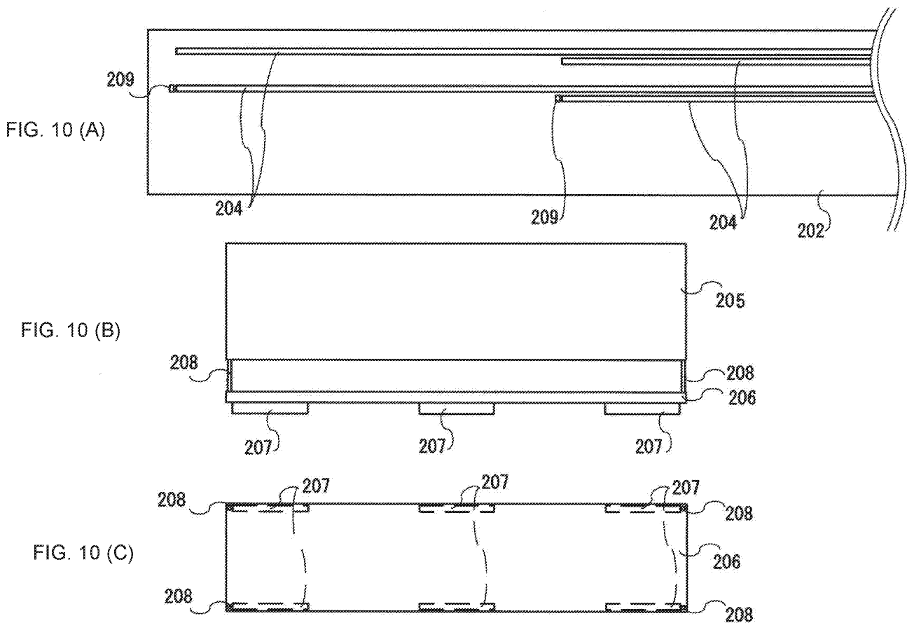

With reference to FIGS. 7 to 10, the present third embodiment is a silica ash producing device 200 which enables further mass production and designed based on the plasma devices 10, 100 for producing the silica ash 19 described above. The present embodiment represents a device which can be used mainly in the burning process S2 and the purification process S3 in the production processes to be described later.

The silica ash producing device 200 is provided with a plurality of storage containers 205 for containing the vegetable material 9 inside a see-through quartz tube 203 in order to mainly enable mass production.

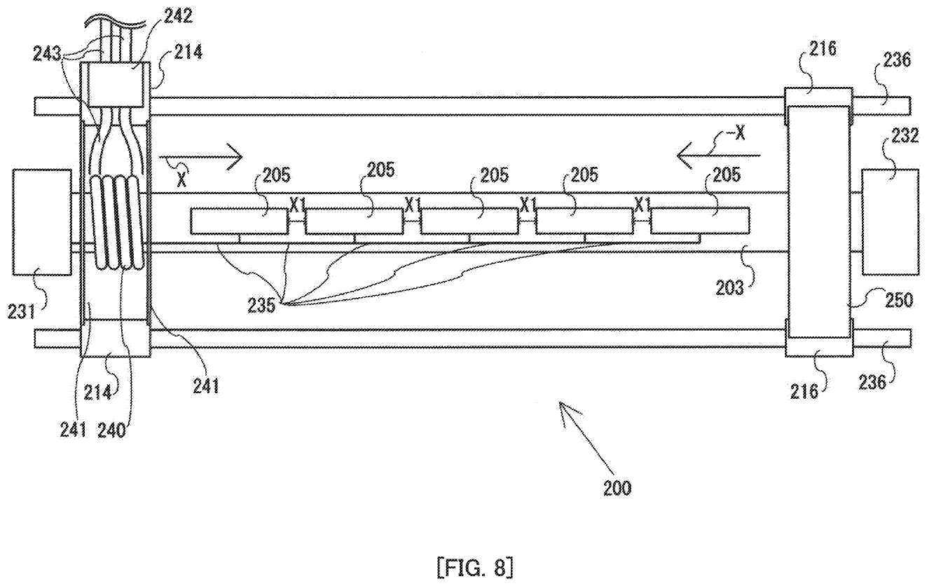

First, with reference to FIGS. 7 and 8, the silica ash producing device 200 will be described. The transparent columnar quartz tube 203 is provided between a left flange 231 and a right flange 232. The left and right flanges 231, 232 enable the quartz tube 203 to be sealed and opened such that the inside of the quartz tube 203 can be maintained in a vacuum state or a low pressure state. In addition, the quartz tube 203 which is a chamber can be detached from one of the left and right flanges 231, 232 which is opened. The left and right flanges 231, 232 have a water cooling type cooling function.

Note that the quartz tube 203 may be detached and fixed from both sides of the left and right flanges 231, 232 so as to be sandwiched by the left and right flanges 231, 232.

As illustrated in FIG. 7, the right flange 232 is connected to a pipe connected to a control valve 224 for controlling the flow rates of an inert gas 217 and a combustion gas 218. Therefore, the quartz tube 203 can be filled with the inert gas 217 or the combustion gas 218. In addition, the right flange 232 is connected to a low vacuum pressure gauge 219, and the left flange 231 is connected to a pressure control valve 222 and the control valve 224 with a filter 221 interposed therebetween.

In addition, the control valve 224 allows one of the inert gas 217 and the combustion gas 218 to flow into the quartz tube 203 in a switchable manner according to the temperature condition and the burning time depending on the process.

A control device 210 performs control such that the internal pressure of the quartz tube 203 can be set to a vacuum pressure, an atmospheric pressure, or 20 atm or higher by using a dry pump 223 connected to the pressure control valve 222 and the control valve 224.

As illustrated in FIGS. 7 and 8, the silica ash producing device 200 includes a high-frequency coil 240 and an electric furnace 250 such that various temperatures can be reached, not only carbon but silica can be extracted from the vegetable material 9, and the silica ash producing device 200 can also be used in the above-described purification process.

The high-frequency coil 240 is formed so as to surround the periphery of the quartz tube 203, and a coil support tool 242 for supporting a coil 243 is fixed to a driving device 1 (214). The driving device 1 (214) moves along rails 236 in the X, -X directions. A motor is used as the driving device 1 (214). Note that linear driving or the like may be used in lieu of the motor.

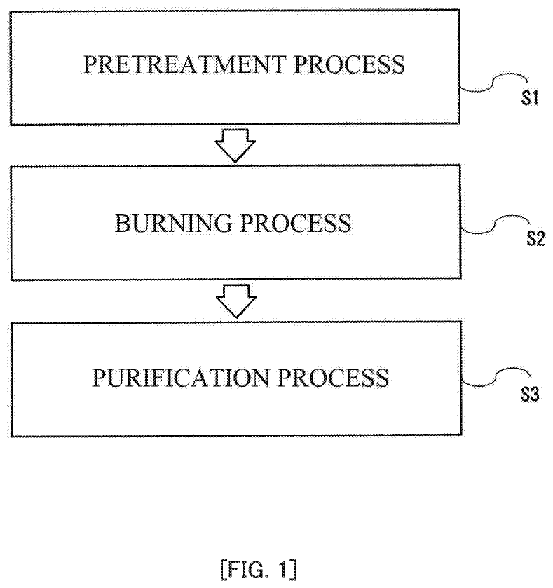

Although the principle and production processes of the silica ash producing device 200 are the same as those of the plasma device 100 of the second embodiment described above, the silica ash producing device 200 differs from the plasma device 100 in that the high-frequency coil 240 is movable in the X and -X directions. Once the high-frequency coil 240 is installed, it is possible to sequentially carbonize the plurality of storage containers 205 storing the vegetable materials 9. Therefore, it is possible to carbonize a large amount of the vegetable materials 9 at a time. Mainly, in the production processes, the high-frequency coil 240 can be utilized in a carbonization process in S2 in FIG. 1 described above.

In addition, the high-frequency coil 240 is provided with a shielding plate 241 in the vicinity of the coil 243 to reduce the influence of electromagnetic waves emitted from the coil 243.

The silica ash producing device 200 makes inert gas 217 flow and applies a high-frequency magnetic field of 4 MHz from a high-frequency power supply 212 to the high-frequency coil 240. Therefore, as illustrated in FIG. 6, thermal plasma was generated and relatively large yields were obtained in a range from 800° C., to 1150° C. inclusive.

By using the high-frequency coil 240 and the inert gas 217 as described above, even lignin which is difficult to be thermally decomposed can be decomposed. In addition, it is optimal for mass production since no toxic substances and the like are generated in the production processes.

Note that besides the plasma device described above, there is a method of producing thermal plasma by a plasma device using barrier discharge, corona discharge, pulse discharge, and DC discharge.

The high-frequency power supply 212 is provided with a water-cooling type cooling device 213 for cooling the coil 243 and the power supply. A filter 221 formed of a nonwoven fabric, cotton, paper, or the like is provided in order to prevent a tar component or the like generated during burning in the quartz tube 203 from affecting the dry pump 223.

In addition, in a temperature control device 211 illustrated in FIGS. 7 and 8, a thermocouple 235 is provided close to each storage container 205 as illustrated in FIG. 8. Therefore, according to information obtained from the temperature control device 211, the control device 210 can perform carbonization at a desired temperature. In particular, temperature control is important because the yield changes depending on the temperature, and the silica ash producing device 200 can extract not only the silica ash 19 but also a large amount of silica from the vegetable material 9 by controlling the temperature.

The electric furnace 250 is formed so as to surround the periphery of the quartz tube 203, and is fixed to a driving device 2 (216). The driving device 2 (216) moves along the rails 236 in the X, -X directions. A motor is used as the driving device 2 (216). Note that linear driving or the like may be used in lieu of the motor.

The electric furnace 250 can raise the temperature up to about 2000° C., and can burn the inside of the quartz tube 203 when refining the vegetable material 9 and the silica ash 19 while supplying the combustion gas 218. In addition, the combustion gas 218 is used for assisting burning, and oxygen or the like is considered as the combustion gas 218. The combustion gas 218 is mainly used in a process in the purification process S3 illustrated in FIG. 1 and is used for burning at about 600° C. In the case of using the electric furnace 250, the control device 210 can also supply air as an air flow into the quartz tube 203 at atmospheric pressure by using the pressure control valve 222 and the control valve 224.

Next, referring to FIGS. 7 to 10, the quartz tube 203 and the storage container 205 will be described.

As illustrated in FIGS. 8, 9, and 10, the storage container 205 is formed of carbon material in a box shape with the upper end thereof opened so as to store the vegetable material 9 and the silica ash 19. In particular, the silica ash producing device 200 is provided with the plurality of storage containers 205 such that more silica ash can be produced than the amount of the silica ash produced by each of the above-described plasma devices 10, 100.

The storage container 205 is fixed to a mounting table 206 including a plurality of upper end piece portions 208 which are rod-shaped projecting pieces and provided at four corners on a front surface of the mounting table 206, and a plurality of lower end piece portions 207 which has a piece shape and projects upward at both ends on the back surface of the mounting table 206. A hole into which the piece of the upper end piece portion 208 can be inserted is formed in the storage container 205, the hole being positioned at the location identical to the position of the upper end piece portion 208 located below. The upper end piece portion 208 is fitted in the hole, and the storage container 205 is fixed to the mounting table 206.

The mounting table 206 to which the storage container 205 is fixed is mounted on a base 202 such that the lower end piece portions 207 are fitted into base grooves 204 which are groove provided in the base 202. A plurality of the base grooves 204 is provided such that the base grooves 204 are shifted from each other by Y1 in the width direction such that the storage containers 205 can be disposed so as to be shifted from each other. In addition, the storage containers 205 are separated not only in the width direction but also in the X direction by a predetermined distance X1 as illustrated in FIG. 8.

By separating the storage containers 205 in the Y1 direction or the X direction, it is attempted to prevent the storage container 205 other than the target of carbonization from being affected as much as possible during carbonization caused by plasma heat. In addition, in order to enable temperature control, in the base 202, a thermocouple storage space 209 which is a space in which the thermocouple can be fixed is secured in the vicinity of the base groove 204.

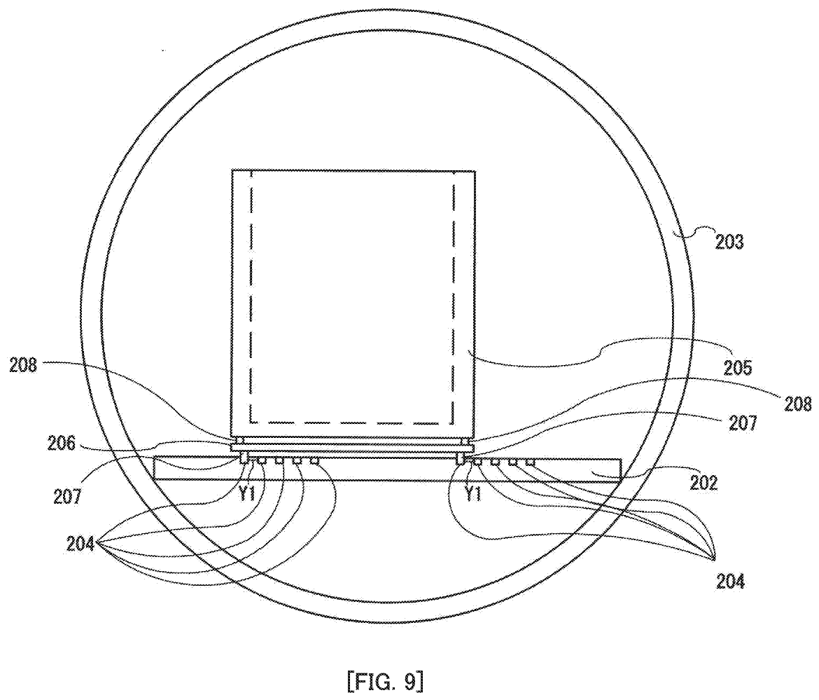

As illustrated in FIG. 9, the quartz tube 203 is formed in a circular tube shape made of transparent quartz and having an outer diameter of about 125 mm. In addition, the base 202 is formed to have a width such that the storage container 205 can be disposed below the center of the inside of the quartz tube 203.

Though the silica ash producing device 200 is configured to obtain silica, it is also possible to extract carbon (graphene) from biomass material depending on temperature conditions. In addition, the electric furnace 250 enables not only the burning process S2 described above but also the purification process S3. Therefore, it is possible to perform various processes while controlling the temperature with identical device.

In the above silica ash producing device 200, since the high-frequency coil 240 or the electric furnace 250, which is a portion applying heat, moves and heats the vegetable material 9 contained in the storage container 205, it is easier to create a space in which pressure can he controlled than in the case of a conveyor type device in which raw material moves. In addition, in the conveyor type device, there is a concern over chemical reaction with oil required for a conveyor or the like, which may cause mixture of impurities. In addition, compared to the conveyor type device, in the silica ash producing device 200, there is no risk of an increase in cost due to complication of the device caused by mixture of inert gas or the like. Since the silica ash producing device 200 is provided outside the quartz tube 203, inspection and maintenance work from the outside is also easy.

In addition, it is also possible to use one device in the processes in the burning process S2 or the purification process S3 to be described later. Further, the silica ash producing device 200 can also produce graphene by changing the temperature conditions. As described above, since the silica ash producing device 200 is a multifunctional device, the device is not only excellent in production efficiency but can be applied to various purposes.

### Fourth Embodiment

Process Flow of Silica Ash Production

With reference to FIG. 1, the production processes for a method of producing nano-level silica will be described. FIG. 1 is a diagram illustrating a process flow depicting processes for producing silica ash 19 according to an embodiment.

First, in the pretreatment process S1, after the vegetable material 9 is dried as described above, the vegetable material 9 is pulverized, and the pulverized vegetable material 9 and a granulating agent are mixed in the ratio of 10 to 1 with water, the mixture is divided into an appropriate size and is kneaded and heated to about 100° C. on a drying device such as a hot plate to evaporate water content and to produce the vegetable material 9.

Here, examples of the pulverizing method include a mill, a blender, a grinder, and the like. In addition, the granulating agent may not be used as long as a net or the like prevents particles from flying in the chamber 1 of the first and second embodiments or the quartz tube 203 of the third embodiment.

Alternatively, the vegetable material 9 may be immersed in a solution obtained by diluting hydrogen chloride (HCL) in the pretreatment process and may be dried, and then the process may proceed to the burning process S2. Part of cellulose is eluted into the diluted hydrogen chloride solution, and the purity after the burning process S2 can be increased.

Next, the burning process S2 in the case of using the plasma device 10, 100 illustrated in FIGS. 2 and 3 of the first embodiment will be described. In the pretreatment process S1, about 0.8 g of the vegetable material 9 is put in the crucible 5 and covered with a metal net or the like. The crucible 5 is disposed at a predetermined heating location in the plasma device 10, 100 described above. The pressure inside the chamber 1 is reduced to 80 Pa by the vacuum pump 30 and the inert gas 6 is injected into the chamber 1 at a flow rate of 8 to 10 ml/min, and the inside of the chamber 1 is maintained at a pressure of 1300 to 1500 Pa.

Similarly, the burning process S2 in the case of using the silica ash producing device 200 illustrated in FIGS. 7 to 10 of the third embodiment will be described. In the pretreatment process S1, the vegetable material 9 is laid in the storage container 205 and covered with a metal net or the like. A plurality of storage containers 205 are disposed so as to be shifted from each other in a predetermined heating location in the silica ash producing device 200 described above. The pressure inside the quartz tube 203 is reduced to 80 Pa by the dry pump 223 and the inert gas 217 is injected into the quartz tube 203 ata flow rate of 8 to 10 ml/min, and the inside of the quartz tube 203 is maintained at a pressure of 1300 to 1500 Pa.

As illustrated in FIG. 6, the applicant performed the burning process S2 in a range from 200° C. to 1100° C. in an increment of 100° C. by thermal plasma in the first and third embodiments, and obtained the temperatures and yields when the vegetable material 9 was carbonized. The value obtained by dividing the weight of the silica ash 19 obtained from 0.8 g of the vegetable material 9 by 0.8 g (the weight of the vegetable material 9) is illustrated in FIG. 6. The highest yield of 36% was obtained in the range from 800° C. to 1150° C., and relatively large yields were obtained in the range from 800° C. to 1150° C. inclusive. Since amorphous silica is in an amorphous state at equal to or lower than 1150° C. or 1000° C., it is preferable to burn the vegetable material 9 at a temperature in the range from 800° C. to 1000° C.

In this measurement, rice straw, rice bran, coconut shell, chaff, and peanut shell, and the like were used, and similar results were obtained.

Next, the purification process S3 in the first embodiment will be described. First, the heating furnace 42 of the impurity removing device 40 illustrated in FIG. 4 of the first embodiment is heated to a high temperature close to 2000° C., the silica ash 19 is put in the large crucible 50, air is made to flow through the large crucible 50, and heating treatment is performed for one hour at a temperature of 600° C. or higher and 1000° C. or lower. Thus, carbon is removed as CO₂, and SiO₂ can be obtained. As a result, highly pure SiO₂ is produced. In order to leave silica in an amorphous state, optimal temperature is 1000° C. or lower.

Similarly, the purification process S3 in the third embodiment will be described. First, the electric furnace 250 of the silica ash producing device 200 illustrated in FIG. 7 of the third embodiment is heated to a high temperature close to 1000° C., burning is performed in the above burning process S2, supply of the inert gas 217 is stopped, the pressure is set to an atmospheric pressure, oxygen which is the combustion gas 218 is supplied into or air is made to flow into the quartz tube 203, the silica ash 19 which has been burned in the above burning process S2 is put in the storage container 205, the storage container 205 is brought into a state where air or oxygen can be supplied therein, and heating treatment is performed for one hour at 600° C. Thus, carbon is removed as CO₂, and SiO₂ can be obtained. As a result, highly pure SiO₂ is produced.

### Process Flow of Silicon

### Fifth Embodiment

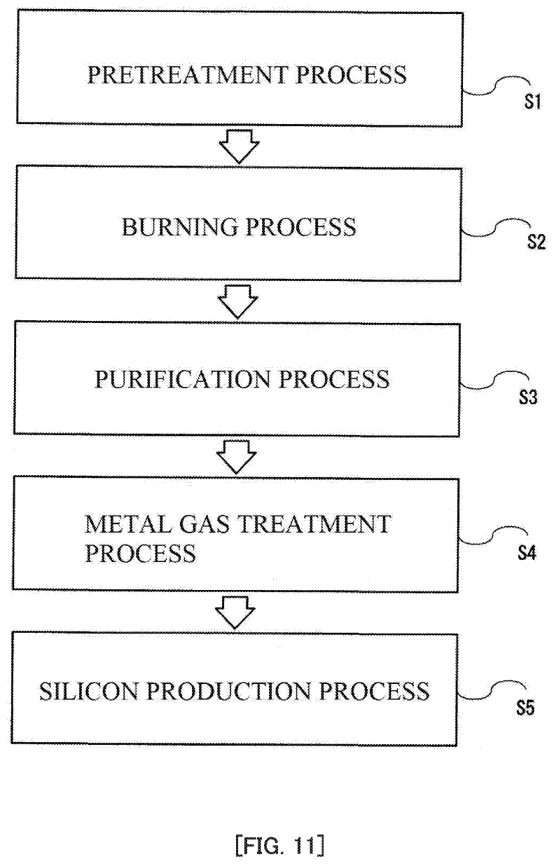

With reference to FIG. 11, production processes for a method of producing silicon will be described. FIG. 11 is a diagram illustrating a process flow depicting processes for producing silicon according to an embodiment. Highly pure SiO₂ produced from the above-described S1 to S3 of the production processes is used and highly pure polycrystalline silicon is produced by processes from S4 to S5.

Silica ash (Si)+3HCl→SiHCl₃+H₂ Chemical formula 1

In the reaction formula of Chemical formula 1, silicon (Si) of the extracted silica ash is reacted with a HCl gas. Reaction temperature is from 300° C. to 350° C. The product obtained after the reaction is a mixture of trichlorosilane gas (SiHCl₃), SiCl₄, and chloride. As described above, trichlorosilane gas (SiHCl₃) is generated in the metal gas treatment process S4.

SiHCl3+H2→polycrystalline Si+3HCl Chemical formula 2

4SiHCl₃→Si+3SiCl₄+2H₂ Chemical formula 3

This highly pure SiHCl₃ and H₂ are reacted in a vacuum state and heated to 1500° C. Then, silicon (Si) and 3SiCl₄ are produced by reduction reaction of SiHCl₃ with H₂ as seen in the reaction formula of Chemical formula 2 and thermal decomposition as seen in the reaction formula of Chemical formula 3, and about ⅓ of SiHCl₂ forms polycrystalline silicon.

In this manner, highly pure polycrystalline silicon (Si) is produced in the silicon production process S5. This silicon is used as a material of a solar cell, a negative electrode material for a fuel cell, and a material of an electronic circuit such as an LSI device or a VLSI device.

Note that a highly pure polycrystalline silicon can be produced by hydrogen reduction and thermal decomposition of halogenated Si such as silicon tetrachloride (SiCl₄), silicon tetrabromide (SiBr₄), and silicon tetraiodide (SiI₄) in addition o trichlorosilane gas (SiHCl₃).
1 Chamber
2 Cathode
3 Anode
4, 32 High-frequency power supply
5 Crusible
6 Inert gas
7 Introduction pipe
8 Lead-out pipe
9 Vegetable material
10, 100 Plasma device
14, 22 Control valve
15, 23 Leak valve
19 Silica ash
20 Control device
21 Gas amount control device
30 Vacuum pump
31 High-frequency coil
40 Impurity removing device
42 Heating furnace
50 Large crusible
51, 61 Lid
52, 62 Vessel
53 Activated carbon
70 Oxidation inhibiting substance
80 Combustion furnace
81 Furnace
83 Pot
200 Silica ash producing device
202 Base
203 Quartz tube
204 Base groove
205 Storage container
206 Mounting table
207 Lower end piece portion
208 Upper end piece portion
209 Storage space
210 Control device
211 Temperature control device
212 High-frequency power supply
213 Cooling device
214 Driving device 1
215 Power supply control device
216 Driving device 2
217 Inert gas
218 Combustion gas
219 Low vacuum pressure gauge
221 Filter
223 Dry pump
224 Control valve
231 Left flange
232 Right flange
235 Thermocouple
236 Rail
240 High-frequency coil
241 Shielding plate
242 Coil support tool
243 Coil
250 Electric furnace
S1 Pretreatment process
S2 Burning process
S3 Purification process
S4 Metal gas treatment process
S5 Silicon production process.

1. A method for producing amorphous silica comprising:
a pretreatment process of pulverizing a vegetable material to obtain a silica source;
a burning process of burning the silica source and extracting silica; and
a purification process of removing carbon from burning material obtained in the burning process,
wherein the burning process includes a heating process of supplying an inert gas into a chamber and heating the silica source in the chamber in a plasma atmosphere.

2. The method for producing amorphous silica according to claim 1, wherein the heating process includes heating at a temperature of 800° C. or higher and 1000° C. or lower.

3. The method for producing amorphous silica according to claim 1, wherein the purification process includes a carbon removing process of firing carbon remaining in the burning material obtained in the burning process in air or an atmosphere to remove the carbon.

4. The method for producing amorphous silica according to claim 3, wherein the purification process includes a firing process of firing the burning material at a temperature of 600° C. or higher and 1000° C. or lower.

5. The method for producing amorphous silica according claim 1, wherein the pretreatment process includes an elution process of immersing the vegetable material in a solution diluted with hydrogen chloride to elute cellulose.

6. Amorphous silica produced by the method for producing amorphous silica according to claim 1, wherein the vegetable material contains 13% or more and 35% or less of silicon oxide.

7. .A device for producing amorphous silica comprising;
a pressure adjusting unit configured to adjust pressure in a chamber;
a gas unit configured to selectively supply a plurality of types of gases into the chamber in a switchable manner;
a burning unit having a plurality of burning modes; and
a plurality of storage containers configured to contain an object to be burned,
the burning unit including a movable burning device configured to move to the storage container which is a target and to be switchable to a mode for burning the object so as to be driven.

8. The device for producing amorphous silica according to claim 7,
wherein the movable burning device includes:
a heating plasma device configured to move from one side, supply an inert gas and perform heating in a plasma atmosphere; and
an electric furnace device configured to move from another side, supply a gas different from the inert gas, and perform heating.

9. The device for producing amorphous silica according to claim 7, wherein the storage containers stored in the chamber is disposed at locations separated from each other in a longitudinal direction anal not overlapping with each other in a width direction.

10. A method of producing silicon comprising:
a metal gas treatment process of reacting silicon of the amorphous silica produced by the method for producing amorphous silica according to claim 1 with a HCl gas to produce a trichlorosilane gas; and
a silicon production process of supplying the trichlorosilane gas produced in the metal gas treatment process and a hydrogen gas to produce silicon by hydrogen reduction and thermal decomposition in a vacuum state.

11. Silicon produced by the method of producing silicon according to claim 10.
